(19) United States
(12) Patent Application Publication
(10) Pub. No.: US 2007/0074779 A1
(43) Pub. Date: Apr. 5, 2007

(54) Safety piping system

(76) Inventor: Sung Suk Kim, Portland, OR (US)

Correspondence Address: Sung Suk Kim, 4467 N.E. 133rd, Portland, OR, 97230, US

(21) Appl. No.: 11/237,415

(22) Filed: Sep. 27, 2005

(51) Int. Cl. F16L 9/00

(52) U.S. Cl. 138/177; 138/178

(57) ABSTRACT

A piping system for use in carrying liquid, air, gasses, or wiring which consists of rounded pipe with one flattened edge, and connectors which are designed to be compatible with the uniquely shaped pipe sections. The piping system is constructed of durable, heat-resistant carbon fiber material which preserves the integrity of the system to temperatures of 5,400 degrees Farenheit (3000 degrees Celcius). The flat pipe edge allows for easy installation directly against building surfaces, while reducing rolling of pipe before and during installation.

### CROSS-REFERENCE TO RELATED APPLICATIONS

Not Applicable

### FEDERALLY SPONSORED RESEARCH

Not Applicable

### REFERENCE TO COMPACT DISC APPENDIX

Not Applicable

### BACKGROUND OF THE INVENTION

The present invention relates to a highly fire-damage resistant durable carbon fiber piping system which consists of semi-circular tubing with a flat edge, along with compatible connectors and fastener accessories. The invention provides a pipe system for use in the delivery of water or other fluids, air, gasses, or wiring. The system offers building occupant safety through the ability of the pipe to remain operational and unaffected by extremely high temperatures, as well as cost-effectiveness through durability, long-life of the material, and ease of installation due to the flat-edge design. Traditional PVC pipe, which the safety pipe replaces, is inferior due to low temperature melting and susceptibility to damage.

### BRIEF SUMMARY OF THE INVENTION

It is the primary object of the present invention to provide a pipe system ranging in outside diameter from ¾ Inch to 12 Inches which offers ease of installation through use of a semi-curcular design featuring a flat edge surface area which eliminates rolling before and during installation.

It is another primary object to provide a pipe design which has a portion of flattened surface area allowing placement directly against a surface for aesthetic improvement in locations where the pipe is visible to the public.

It is another object of the invention to provide for safety and cost-effectiveness through use of carbon fiber material employed in manufacture of the pipe and accessories which is heat-resistant to 5,400 degrees Farenheit (3000 degrees Celcius) ensuring the integrity of the piping system for its intended purpose and remaining structurally sound after exposure to intense heat.

### BRIEF DESCRIPTION OF THE SEVERAL VIEWS OF THE DRAWING

The embodiment of the invention is illustrated in its design and construction and will be more fully understood from the following description, when read in conjunction with the accompanying drawings where:

FIG. 1 is an overall view of the safety pipe with exposed end showing the semi-circular casing, with one edge being flat.

FIG. 2 is a frontal view of the pipe showing the rounded pipe wall with one flat end, and the thickness of the pipe wall in comparison to the interior diameter of the pipe.

FIG. 3 represents a side-view of the pipe with the pipe wall thickness represented by the interior dashed line.

FIG. 4 shows a section of pipe at a perspective angle with the flat interior portion of the pipe shown.

FIG. 5 represents a carbon fiber T-connector which allows three sections of safety pipe to be joined.

FIG. 6 shows a 90 degree elbow section made of carbon fiber and crafted to accommodate the shape of the safety pipe.

FIG. 7 shows a 45 degree elbow section made of carbon fiber and crafted to accommodate the shape of the safety pipe.

FIG. 8 shows a 30 degree elbow section made of carbon fiber and crafted to accommodate the shape of the safety pipe.

FIG. 9 is a double bracket made of carbon fiber used to secure the safety pipe to a surface structure on both sides of the pipe.

FIG. 10 is a bracket made of carbon fiber used to secure the safety pipe to a surface structure on one side of the pipe.

### DETAILED DESCRIPTION OF THE INVENTION

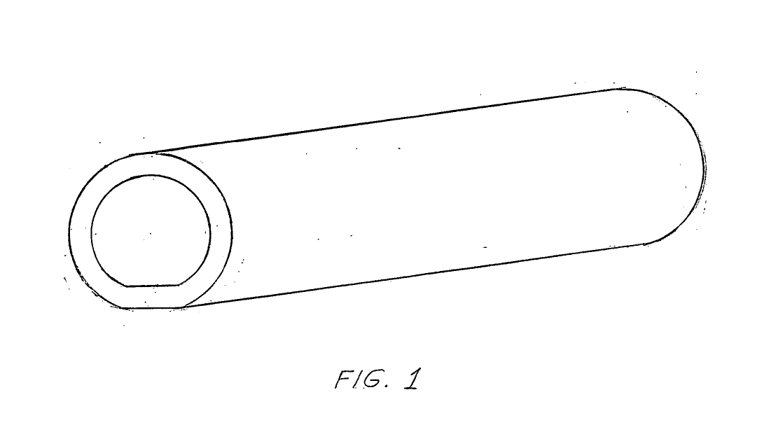

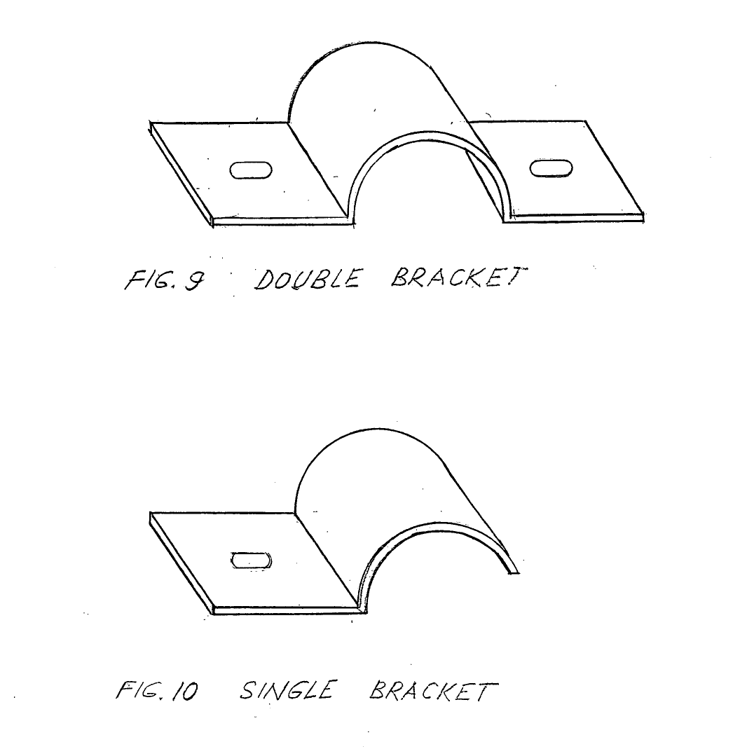

The safety piping system pipe design is depicted through FIGS. 1, 2, 3, and 4 which shows the shape of the pipe from several perspectives. FIGS. 5, 6, 7, and 8 represent various connectors for joining the safety pipe. FIGS. 9 and 10 depict standard fastening components for pipe and are not sought to be patented through this application.

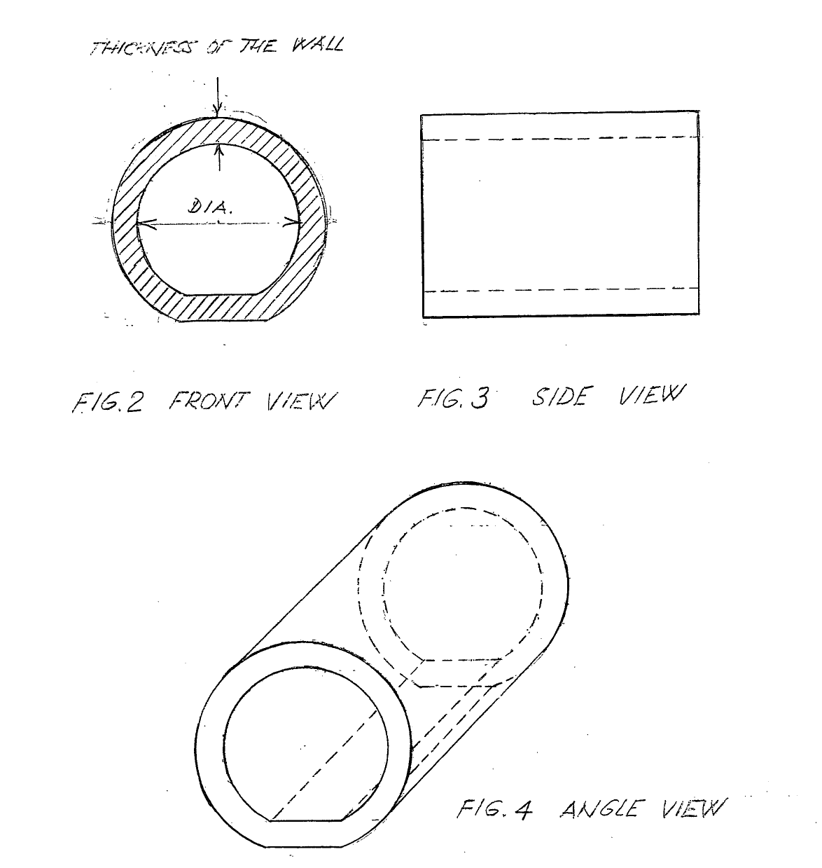

Referring to FIG. 1, the overall view of the carbon fiber pipe is shown, which consists of a tubular, standard circular shape with the exception of a flat edge bisecting the pipe on the exterior pipe surface and interior pipe wall. FIGS. 2, 3, and 4 demonstrate further representations of the pipe shape.

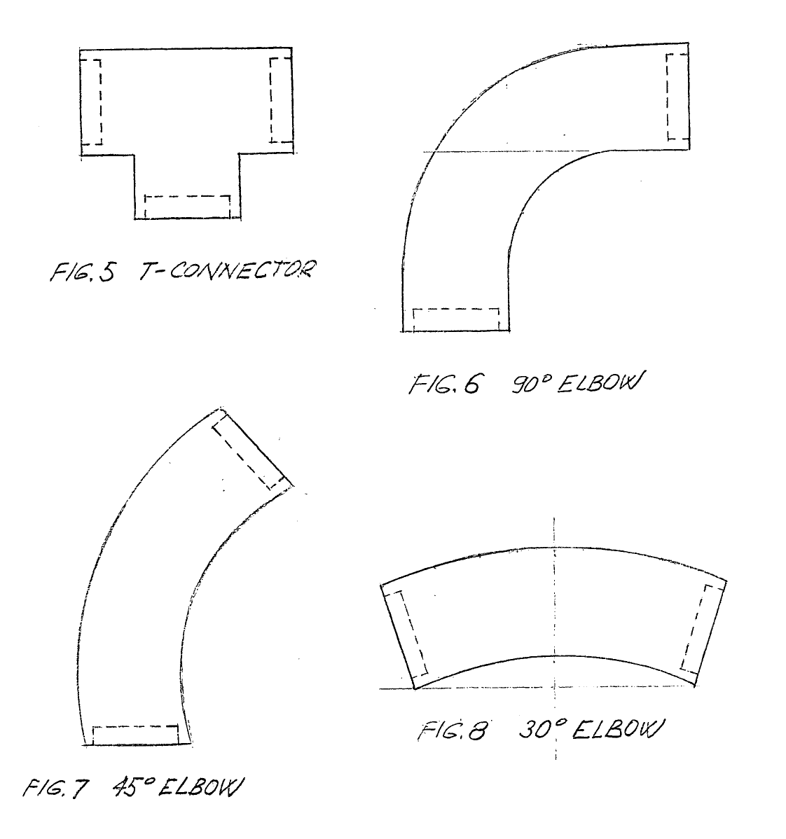

FIGS. 5, 6, 7, and 8 are connectors designed specifically for use in joining safety pipe as represented in FIGS. 1 through 4, and represent designs which accommodate the shape of the safety pipe. FIG. 5 is designed to join three sections of pipe. FIGS. 6, 7, and 8 are elbow sections of differing angles.

While certain novel features of the safety piping system have been shown and described either in part or in full and pointed out in the annexed claims, it is not limited to those details, since it is understood that various omissions, modifications, substitutions and/or changes in the forms and details of the invention illustrated and in its operation can be made by those skilled in the art without departing from, in any way, the spirit of the present invention.

Without further analysis, the foregoing will so fully reveal the art of the safety piping system that others can by applying current knowledge, readily adapt it for various applications without omitting features that from the standpoint of prior art, fairly constitute essential characteristics and the generic or specific aspects of this invention.

What I claim as my invention is as follows:

1. A piping system which consists of piping sections crafted with heat resistant carbon fiber material consisting of rounded pipe with one flattened surface edge.
